(19) United States
(12) Patent Application Publication
(10) Pub. No.: US 2023/0305305 A1
(43) Pub. Date: Sep. 28, 2023

(54) COMPENSATED DIFFRACTIVE WAVEGUIDE FOR OFF-AXIS IN-COUPLING AND VIEWING

(71) Applicant: InterDigital CE Patent Holdings, SAS, Paris (FR)

(72) Inventors: Valter Drazic, Betton (FR); Valerie Allie, Saint-Armel (FR)

(21) Appl. No.: 18/020,255

(22) PCT Filed: Aug. 9, 2021
(86) PCT No.: PCT/EP2021/072141

§ 371 Date: Feb. 7, 2023

(30) Foreign Application Priority Data
Aug. 13, 2020 (EP) 20305927.4

(51) Int. Cl. G02B 27/01; F21V 8/00; G06T 5/00

(52) U.S. Cl. CPC G02B 27/0172; G02B 6/0023; G06T 5/001; G02B 2027/0132; G02B 2027/0178; G02B 2027/0116

(57) ABSTRACT

Example embodiments include a display apparatus having an image generator, a waveguide having an in-coupler and an out-coupler, and a prism or other light-deflecting component along an optical path between the image generator and the in-coupler. The image generator may have an optical axis that is not normal to the waveguide, and the waveguide may not be normal to a line of sight. The prism may be configured to deflect light such that light emitted along the optical axis is deflected to a direction such that the light from the optical axis is out-coupled at a direction substantially parallel to the line of sight. The non-normal arrangement of the image generator and line of sight with respect to the waveguide may allow a glasses-like display to better accommodate the form of a user's head.

### CROSS-REFERENCE TO RELATED APPLICATIONS

The present application claims priority from European Patent Application No. EP20305927, filed Aug. 13, 2020, entitled “COMPENSATED DIFFRACTIVE WAVEGUIDE FOR OFF-AXIS IN-COUPLING AND VIEWING.”

### BACKGROUND

The present disclosure relates to the field of optics and photonics, and more specifically to an optical device comprising at least one diffraction grating. It may find applications in the field of conformable and wearable optics (e.g. ARNR glasses (Augmented Reality/Virtual Reality)), as well as in a variety of other electronic consumer products comprising displays and/or lightweight imaging systems, including head up displays (HUD), as for example in the automotive industry.

This section is intended to introduce the reader to various aspects of art, which may be related to various aspects of the present disclosure that are described and/or claimed below. This discussion is believed to be helpful in providing the reader with background information to facilitate a better understanding of the various aspects of the systems and methods described herein. Accordingly, it should be understood that these statements are to be read in this light, and not as admissions of prior art.

ARNR glasses are under consideration for a new generation of human-machine interface. Development of AR/VR glasses (and more generally eyewear electronic devices) is associated with a number of challenges, including reduction of size and weight of such devices as well as improvement of the image quality (in terms of contrast, field of view, color depth, etc.) that should be realistic enough to enable a truly immersive user experience.

The tradeoff between the image quality and physical size of the optical components motivates research into ultra-compact optical components that can be used as building blocks for more complex optical systems, such as ARNR glasses. It is desirable for such optical components to be easy to fabricate and replicate.

In such ARNR glasses, various types of refractive and diffractive lenses and beam-forming components are used to guide the light from a micro-display or a projector towards the human eye, allowing formation of a virtual image that is superimposed with an image of the physical world seen with a naked eye (in case of AR glasses) or captured by a camera (in case of VR glasses). Some of kinds of ARNR glasses utilize an optical waveguide wherein light propagates into the optical waveguide by TIR (for Total Internal Reflection) only over a limited range of internal angles. The FoV (for Field of View) of the waveguide depends on the material of the waveguide, among other factors.

### SUMMARY

References in the specification to “one embodiment,” “an embodiment,” “an example embodiment,” and the like indicate that the embodiment described may include a particular feature, structure, or characteristic; but not every embodiment necessarily includes that particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described.

An apparatus according to some embodiments comprises an image generator, a waveguide having at least an in-coupler and an out-coupler, and a light-deflecting optical element along an optical path between the image generator and the in-coupler, the light-deflecting optical element comprising at least one of a single prism, a blazed prism, two mirrors, or a holographic optical element.

In some embodiments, the apparatus comprises a frame having a temple arm, and the image generator is mounted inboard of the temple arm.

In some embodiments, the light-deflecting optical element is a non-focusing optical element.

In some embodiments, an optical axis of the image generator is mounted at an angle of at least 5° with respect to a normal to the waveguide. In some embodiments, the optical axis of the image generator is mounted at an angle of at least 10° with respect to a normal to the waveguide. In some embodiments, the optical axis of the image generator is mounted at an angle of about 19.1° with respect to a normal to the waveguide.

In some embodiments, the prism is configured to refract light emitted along the optical axis of the waveguide to a direction that is coupled out of the waveguide in a direction parallel to a line of sight, where the line of sight may be an axis of symmetry of the apparatus.

In some embodiments, the waveguide is a first waveguide in a binocular display having two waveguides. In some such embodiments, the binocular display has a centerline, and each of the waveguides has a normal that is oriented at an angle of at least 2° away from the centerline. In some embodiments, each of the waveguides has a normal that is oriented at an angle of about 5° away from the centerline.

In some embodiments, the apparatus further comprises a preprocessing module, the preprocessing module being operative to preprocess a received image to account for distortion introduced by the light-deflecting optical element.

A method according to some embodiments comprises emitting light representing an image from an image generator along an optical path toward an in-coupler of a waveguide, wherein the waveguide is not normal to an optical axis of the image generator; and deflecting the emitted light using a light-deflecting optical element such that light emitted along the optical axis is deflected to a direction such that the light is out-coupled at a direction substantially parallel to a line of sight, the light-deflecting optical element comprising at least one of a single prism, a blazed prism, two mirrors, or a holographic optical element.

In some embodiments, the method is performed by a binocular display, and the line of sight is parallel to a centerline of the binocular display.

In some embodiments, the light-deflecting optical element is a non-focusing optical element.

In some embodiments, the method further comprises receiving image information and preprocessing the received image information to account for distortion introduced by the light-deflecting optical element to generate a processed image, wherein the light emitted from the image generator is based on the preprocessed image.

### BRIEF DESCRIPTION OF THE DRAWINGS

FIG. 1A is a cross-sectional schematic view of a waveguide display.

FIG. 1B is a schematic illustration of a binocular waveguide display with a first layout of diffractive optical components.

FIG. 1C is a schematic illustration of a binocular waveguide display with a second layout of diffractive optical components.

FIG. 1D is a schematic exploded view of a double-waveguide display according to some embodiments.

FIG. 1E is a cross-sectional schematic view of a double-waveguide display according to some embodiments.

FIG. 2 is a schematic view from below of an example waveguide display configuration worn by a user.

FIG. 3A is a schematic illustration of a waveguide display configuration in which an image generator is normal to the waveguide but the waveguide is angled from the user's line of sight.

FIG. 3B is a schematic illustration of a waveguide display configuration in which an image generator is not normal to the waveguide.

FIG. 4 is a schematic illustration of a layout of diffraction gratings in a waveguide display used in some embodiments.

FIG. 5 is a schematic view of a waveguide illustrating dispersion of color components of a full-color image coupled into the waveguide.

FIG. 6 is a schematic top view of a waveguide display layout including a prism according to some embodiments.

FIG. 7 is a data visualization of the effect of a waveguide display according to some embodiments on light transmitted through the display in the wave space domain (top row) and the x-y domain (bottom row) for three different colors.

FIG. 8 is a data visualization of the effect of a waveguide display according to some embodiments on light transmitted through the display.

FIG. 9 is a schematic top view of a binocular waveguide display according to some embodiments.

FIG. 10 is a schematic top view of a waveguide display layout including a pair of mirrors according to some embodiments.

FIG. 11 is a schematic top view of a waveguide display layout including a blazed prism according to some embodiments.

FIG. 12 is a schematic top view of a waveguide display layout including a holographic optical element according to some embodiments.

FIG. 13 is a schematic cross-sectional view of a recording process being performed on a holographic optical element.

### DETAILED DESCRIPTION

### Overview of Example Waveguide Architecture.

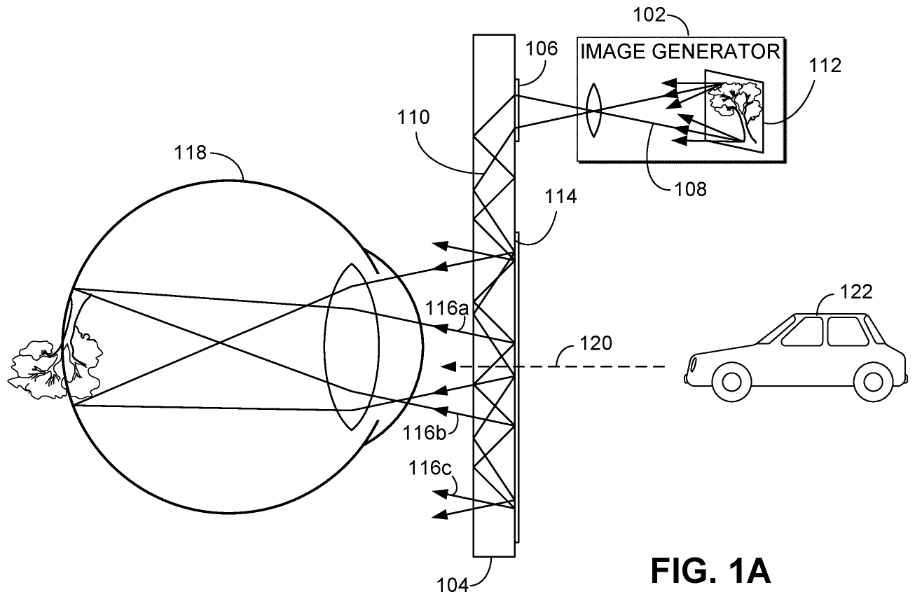

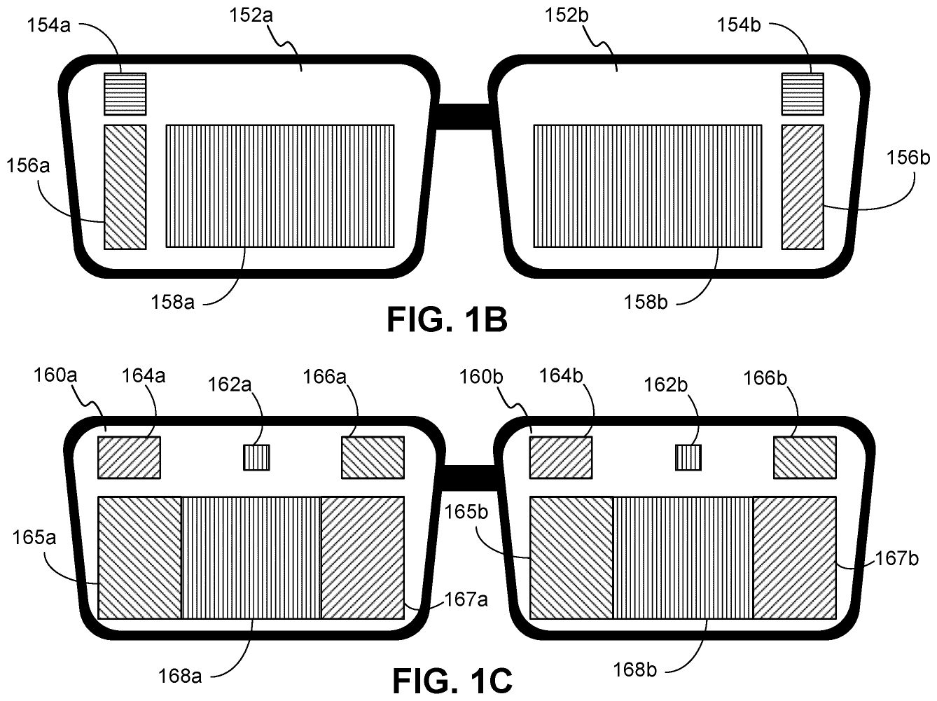

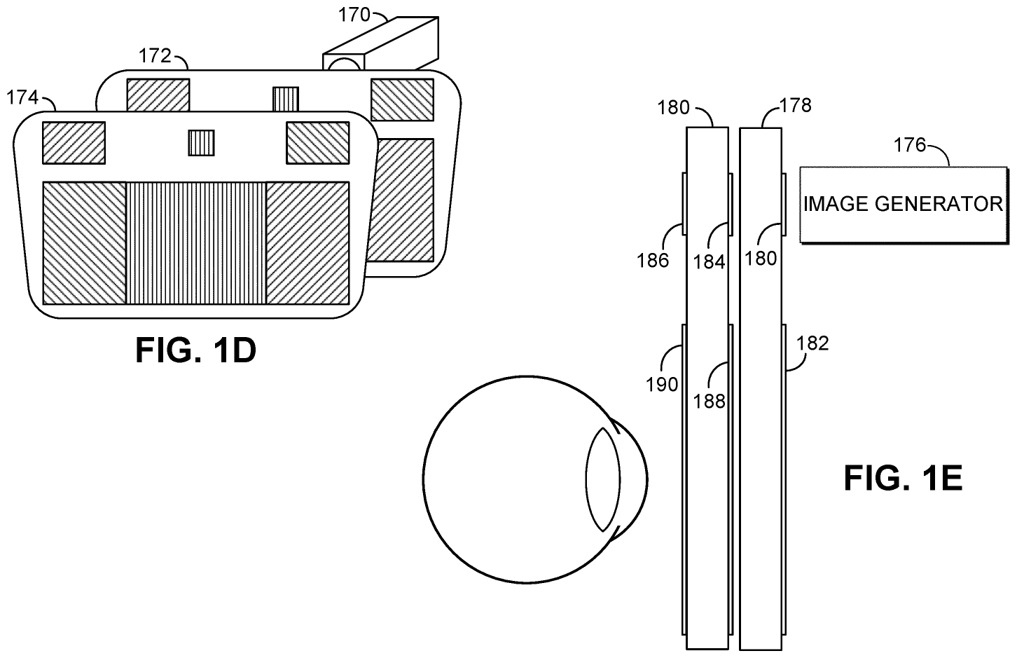

Described herein are waveguide display systems and methods. An example waveguide display device is illustrated in FIG. 1A. FIG. 1A is a schematic cross-sectional side view of a waveguide display device in operation. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (PLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A users eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the users eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

In some embodiments, as described in further detail below, a waveguide display includes more than one waveguide layer. Each waveguide layer may be configured to preferentially convey light with a particular range of wavelengths and/or incident angles from the image generator to the viewer.

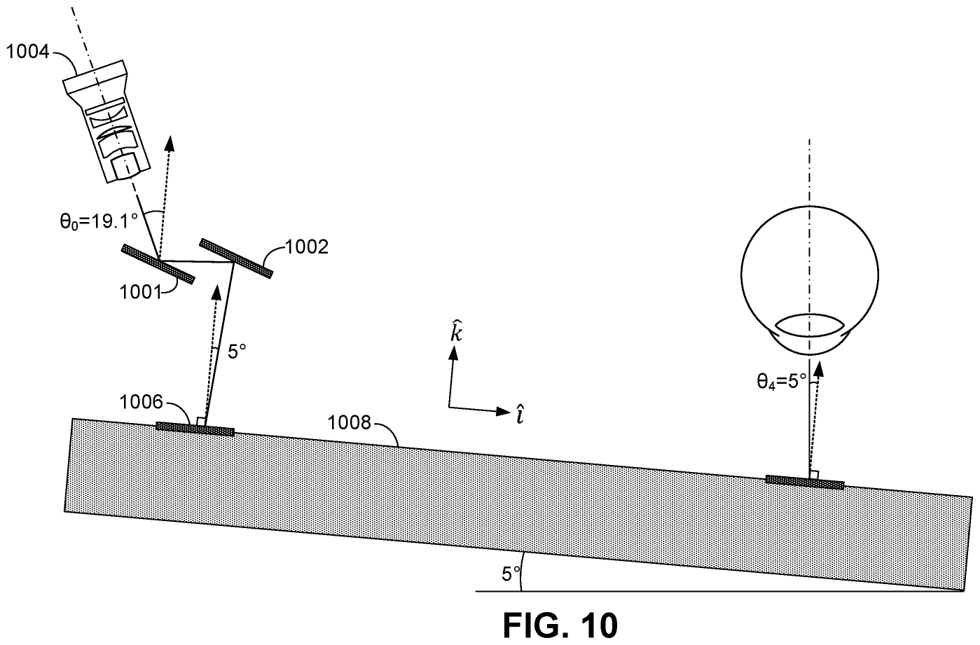

As illustrated in FIGS. 1B and 10, waveguide displays having in-couplers, out-couplers, and pupil expanders may have various different configurations. An example layout of one binocular waveguide display is illustrated in FIG. 1B. In the example of FIG. 1B, the display includes waveguides 152a, 152b for the left and right eyes, respectively. The waveguides include in-couplers 154a,b, pupil expanders 156a,b, and components 158a,b, which operate as both out-couplers and horizontal pupil expanders. The pupil expanders 156a,b are arranged along an optical path between the in-coupler and the out-coupler. An image generator (not shown) may be provided for each eye and arranged to project light representing an image on the respective in-coupler.

An example layout of another binocular waveguide display is illustrated in FIG. 10. In the example of FIG. 10, the display includes waveguides 160a, 160b for the left and right eyes, respectively. The waveguides include in-couplers 162a,b. Light from different portions of an image may be coupled by the in-couplers 162a,b to different directions within the waveguides. In-coupled light traveling toward the left passes through pupil expanders 164a,b and 165a,b, while in-coupled light traveling toward the right passes through pupil expanders 166a,b and 167a,b. Having passed through the pupil expanders, light is coupled out of the waveguides using out-couplers 168a,b to substantially replicate an image provided at the in-couplers 162a,b.

In different embodiments, different features of the waveguide displays may be provided on different surfaces of the waveguides. For example (as in the configuration of FIG. 1A), the in-coupler and the out-coupler may both be arranged on the anterior surface of the waveguide (away from the user's eye). In other embodiments, the in-coupler and/or the out-coupler may be on a posterior surface of the waveguide (toward the users eye). The in-coupler and out-coupler may be on opposite surfaces of the waveguide. In some embodiments, one or more of an in-coupler, an out-coupler, and a pupil expander, may be present on both surfaces of the waveguide. The image generator may be arranged toward the anterior surface or toward the posterior surface of the waveguide. The in-coupler is not necessarily on the same side of the waveguide as the image generator. Any pupil expanders in a waveguide may be arranged on the anterior surface, on the posterior surface, or on both surfaces of the waveguide. In displays with more than one waveguide layer, different layers may have different configurations of in-coupler, out-coupler, and pupil expander.

FIG. 1D is a schematic exploded view of a double waveguide display according to some embodiments, including an image generator 170, a first waveguide (WG₁) 172, and a second waveguide (WG₂) 174. FIG. 1E is a schematic side-view of a double waveguide display according to some embodiments, including an image generator 176, a first waveguide (WG₁) 178, and a second waveguide (WG₂) 180. The first waveguide includes a first transmissive diffractive in-coupler (DG₁) 180 and a first diffractive out-coupler (DG6) 182. The second waveguide has a second transmissive diffractive in-coupler (DG₂) 184, a reflective diffractive in-coupler (DG₃) 186, a second diffractive out-coupler (DG₄) 188, and a third diffractive out-coupler (DG₅) 190. Different embodiments may use different arrangements of optical components (such as different arrangements of pupil expanders) on the first and second waveguides.

While FIGS. 1A-1E illustrate the use of waveguides in a near-eye display, the same principles may be used in other display technologies, such as head up displays for automotive or other uses.

### Example Off-Axis Coupling Optics.

To provide a practical set of waveguide display glasses for AR applications, in some embodiments, the waveguide is configured for a non-perpendicular geometry to better correspond to the curvature of the human face.

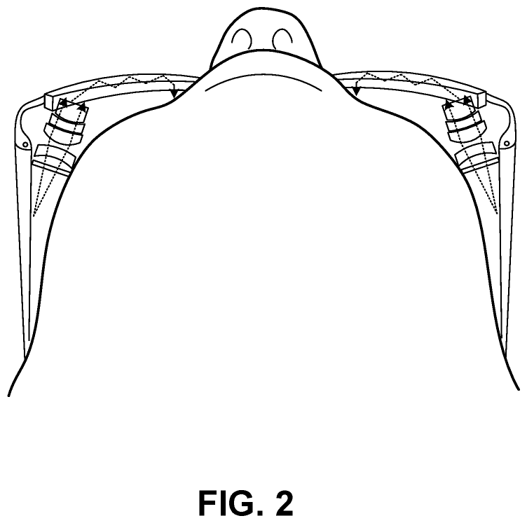

In the example illustrated in FIG. 2, the glasses are bent, but they are also set at an angle. The edge of the glass near to the nose is at a different depth from the edge of the glass near to the temple. If the light engine (or other image generator) drawn on this figure were perpendicular to the glass at in-coupling, due to the distortion constrains of the optical system comprising all diffractive components on the glass, the beam would be out-coupled also perpendicular to the glass plate at the exit. Such a beam, however, would not superimpose with the line of sight. In other words, the virtual image would be off-axis.

In addition to that, the light engine can also be oriented off-axis with respect to the glass-plate. This would put the virtual image even more off-axis from the line of sight. The negative effects of an off-axis line of sight are compounded when the field of view is relatively narrow.

Some embodiments provide a display in which the virtual image is provided in the line of sight even though the waveguide is not perpendicular either to the line of sight or to the light engine.

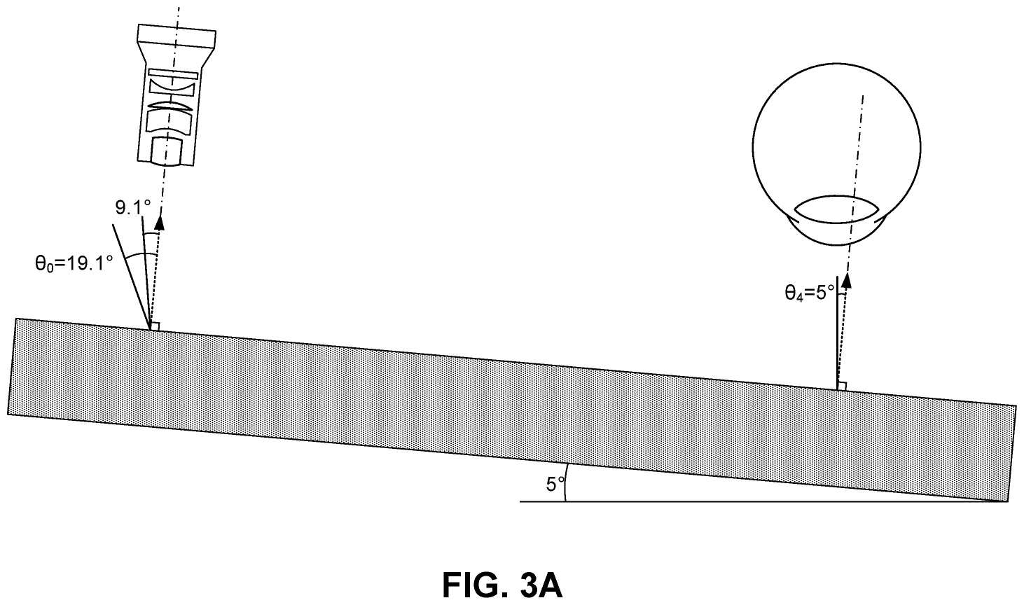

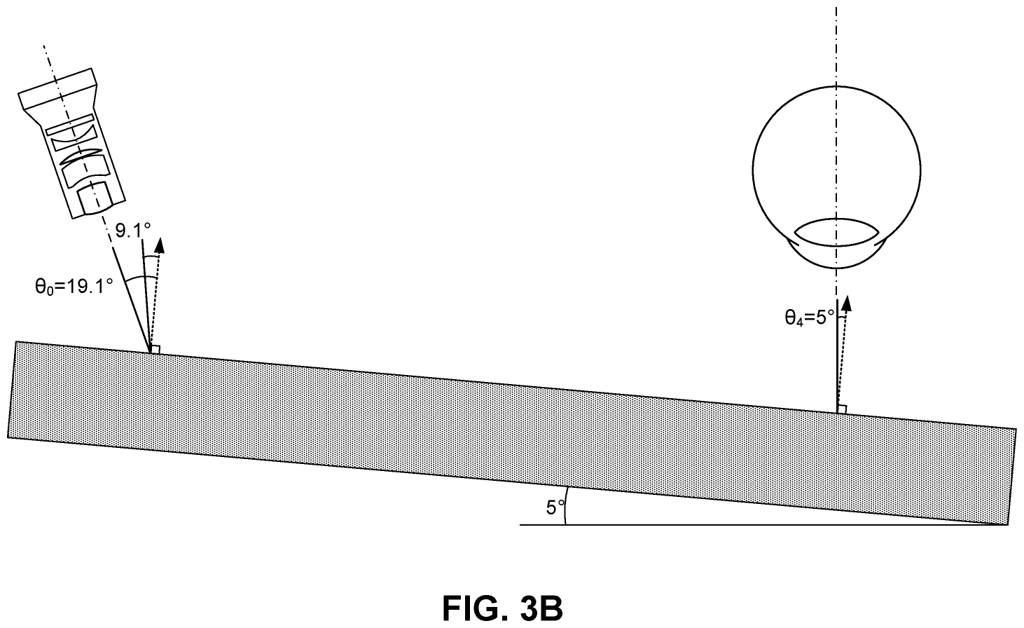

FIG. 3A illustrates a geometry of a system in which the waveguide is not perpendicular to the line of sight but the light engine is perpendicular to the waveguide. The nose location is at the right-hand side of the waveguide, and the view is seen from the top. The waveguide (e.g. a glass plate) has a tilt with respect to the line of sight. The tilt may be represented by an angle between a normal to the waveguide and a line of sight. In the example of FIG. 3A, the tilt angle is 5 degrees. (The direction normal to the waveguide is illustrated in FIGS. 3A, 3B, 6, 10, 11, and 12 as a dotted arrow.) In this configuration, it can be seen that an image coupled at normal incidence into the waveguide will also be out-coupled at normal incidence out of the waveguide, and thus would be off center by 5 degrees with respect to the line of sight. Such an arrangement could reduce the field of view of the display.

FIG. 3B illustrates a second geometry, in which the axis of the light engine is angularly offset with respect to the waveguide normal by an angle of 19.1 degrees to accommodate the geometry of the face. However, it would be desirable for light entering the waveguide at 19.1 degrees from the normal to exit the waveguide at 5 degrees from the normal to align with the line of sight. However, configuring the in-coupler and out-coupler gratings to provide such a geometry would cause the image to be distorted. It is desirable to provide a display geometry with a light engine or other image generator positioned as illustrated in FIG. 3B, but with little to no distortion of the image.

Only one glass waveguide plate is illustrated in FIGS. 3A-3B for use over one eye, but another waveguide may be provided (e.g. in a symmetric arrangement) for the other eye. The nose location is at the right-hand side of the waveguide, and the view is seen from the top.

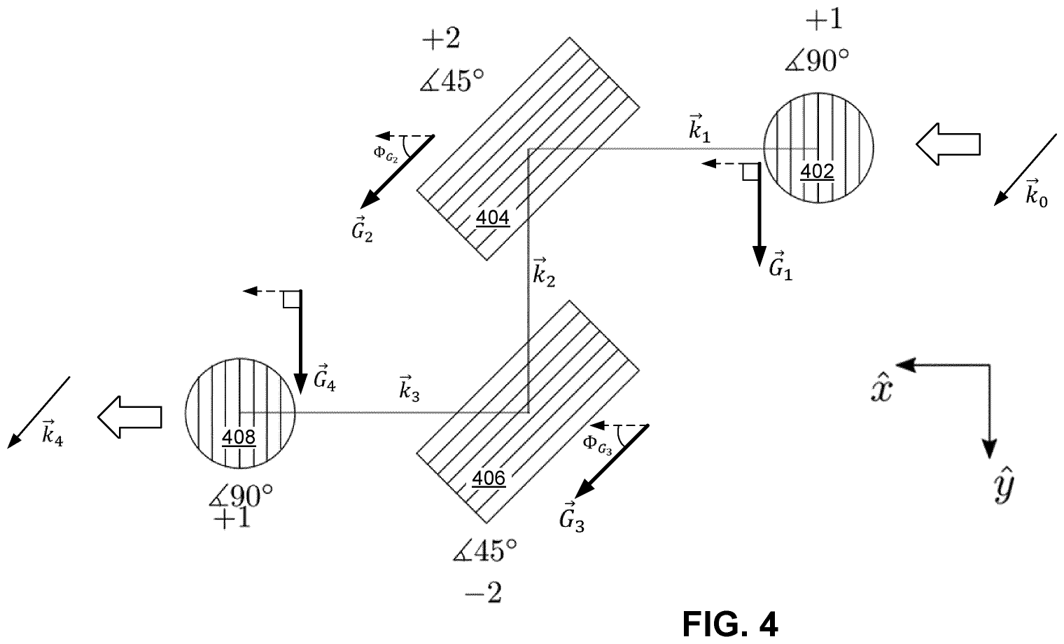

In some embodiments, the diffraction gratings on the waveguide have a generally S-shaped geometry as illustrated in FIG. 4. In the example of FIG. 4, an in-coupler 402 diffracts the +1 mode, but in some embodiments it diffracts the +2 mode. The two eye pupil expanders 404 and 406 are set in a parallel configuration, and the out coupler 408 diffracts the +1 order out of the system.

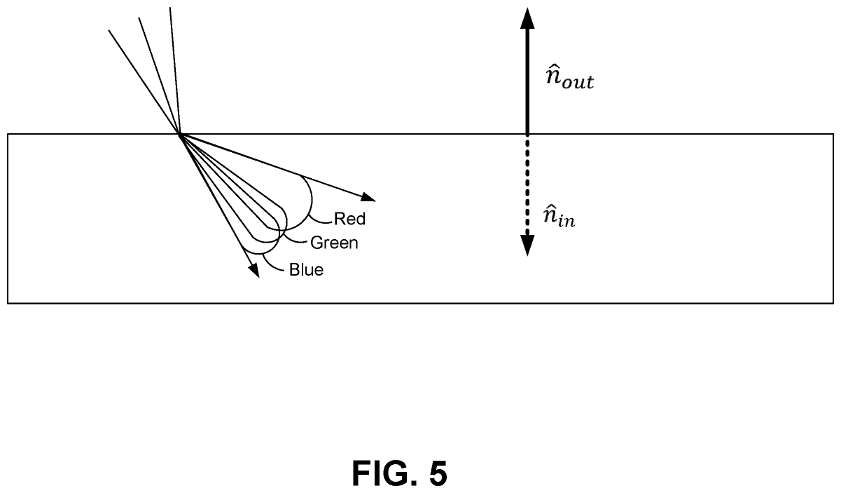

In example embodiments, a full-color image is provide using three color components at 450 nm, 520 nm, and 638 nm respectively for blue, green, and red light. In some embodiments, the system includes only one waveguide (or one for each eye). The in-coupler diffract the three wavelengths at different mean angles into the waveguide, as shown in FIG. 5, where the input is RGB.

If the wave vector at input is indexed by 0, the wave vector after the in coupler by 1, after the first EPE 404 by 2, after the second EPE 406 by 3 and after the out coupler 408 by 4, then the relationship between the in-coupled wave vector \vec{k}₀, and the out-coupled wave vector \vec{k}₄ may be expressed as follows

(\vec{k}₄−\vec{k}₀)∧\hat{n}ₒᵤₜ=M₄\vec{G}₄+M₃\vec{G}₃+M₂\vec{G}₂−M₁\vec{G}₁

Where Mᵢ are the diffraction orders of the respective gratings, the di are the grating vectors, and \hat{n}ₒᵤₜ is the waveguide's normal. This equation leads to two conditions, expressed in terms alpha factors which are the dimensionless grating parameters:

The first condition:

$${α}_{i} = \frac{{M}_{i} λ}{{Λ}_{i}} .$$

α₂ cos(Φ_{G}_{₂})+α₃ cos(Φ_{G}_{₃})=0

is achieved when the two EPEs have the same orientation (Φ_{G}_{₂}=(Φ_{G}_{₃}) and α₃=−α₂.

The second condition is

α₄−α₁+α₂ sin(Φ_{G}_{₂})+α₃ sin(Φ_{G}_{₃})=sin(θ₄)+sin(θ₀)

where the theta angles are the angles of the wave vector at the in-coupler and out-coupler, with respect to the normal. The second condition can be developed into

$$\frac{{M}_{4}}{{Λ}_{4}} - \frac{{M}_{1}}{{Λ}_{1}} + \frac{{M}_{2}}{{Λ}_{2}} sin {Φ}_{{G}_{2}} + \frac{{M}_{3}}{{Λ}_{3}} sin {Φ}_{{G}_{3}} = \frac{sin {θ}_{4} + sin {θ}_{1}}{λ}$$

The first part of the equation is a constant for the display configuration. But the second part depends on the wavelength. This indicates that distortion-free imaging for a configuration such as that of FIG. 3B cannot be achieved for all wavelengths, because the equation is satisfied for all wavelengths only if θ₄=−θ₁, but that solution violates the goal of providing different input angles (e.g. 19.1°) and output angles (e.g. 5°). To avoid distortion, it is desirable for light to be coupled into the waveguide at the same angle as the desired output, at least in absolute value.

Example embodiments operate to compensate the waveguide for low distortion imaging from the display to the eye by introducing a prism before the in-coupler.

The prism's angle is selected to deviate the direction of the center of the image from its original off-axis direction (for example −19.1°) to a desired off-axis output direction (e.g. +5°). The waveguide then reproduces the angle of the in-coupled light at the out-coupler to provide imaging with low or no distortion.

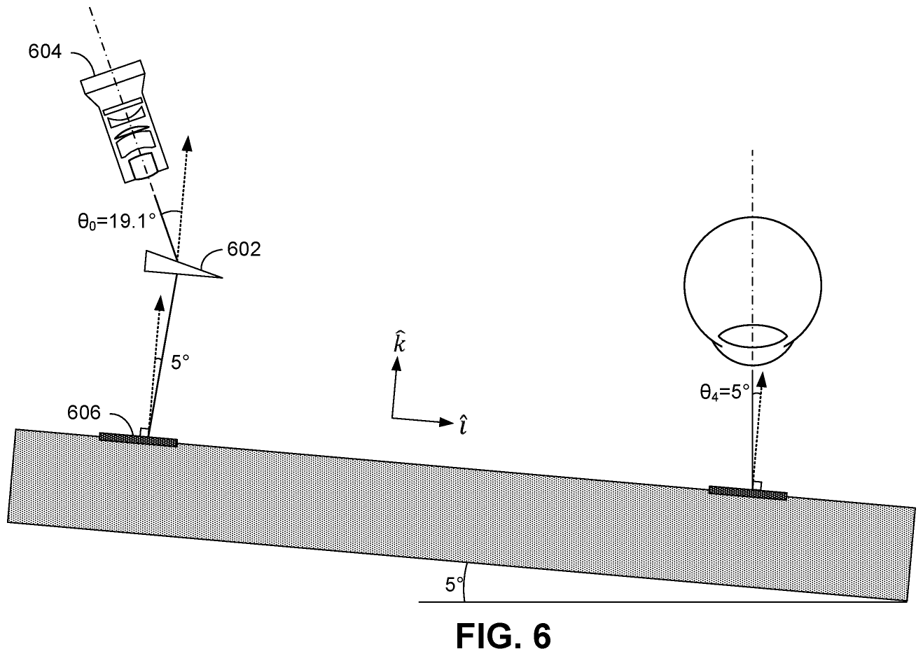

A schematic illustration of an example embodiment is provided in FIG. 6. In the illustration of FIG. 6, a prism 602 is provided along an optical path between a light engine or other image generator 604 and an in-coupler 606 of the waveguide. The prism 602 may be a non-focusing light-deflecting optical element that provides the desired optical path without requiring changes to the focusing optics associated with the image generator 604.

The operation of an example embodiment may be described using a k-diagram to represent the passage of light from before the prism to the output in the angular domain. The operation may also be described using a spot diagram in the x-y domain on the display and the retina side.

In an example embodiment, the waveguide and prism both have a refractive index of 2.0, although in other embodiments, the components may have different refractive indices, and the refractive indices of the components are not necessarily the same.

In an example embodiment, the in-coupler has a pitch size of 682 nm and is configured to diffract light using the +2 order. Both eye pupil expanders have angles of 45°, pitches of 553.5 nm, and are configured to diffract light using the +2 order. The out-coupler has a pitch size of 341 nm and is configured to use the +1 diffractive order. In this example, the image coupled into the waveguide is an RGB image having wavelengths of 450 nm, 520 nm, and 638 nm. Such a system may provide a horizontal field of view of 26° and a vertical field of view of 18°. In this example, a triangular prism is used with an angle of 21.48°. While features of the performance of a system having these parameters is described here, it should be noted that other parameters may alternatively be used in other embodiments.

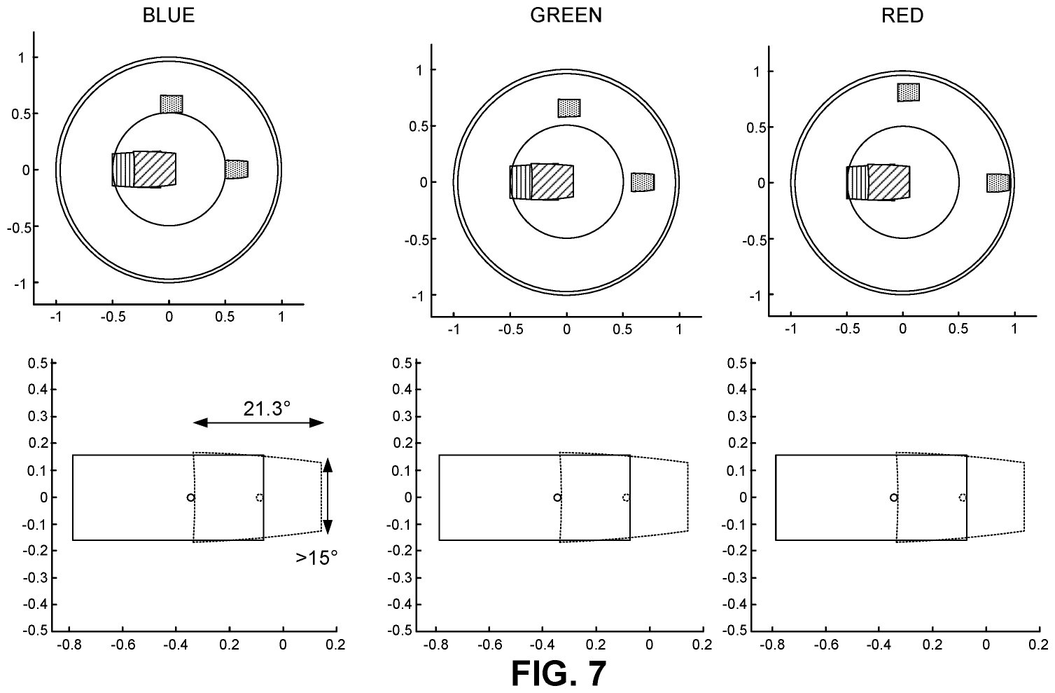

FIG. 7 illustrates in the top row the kx-ky diagrams for the three wavelengths. The bottom row is the spot diagram of the display (rectangle on left) with its center of the image at 19.1° (−0.33 radians in the figure) and the spot diagram on the retina (rounded trapezoidal shape on right) with the center of the image at 5° (−0.087 radians in the figure). The spot diagrams at the retina for all three colors are substantially superimposable on one another for all three colors.

As the distortion is substantially uniform for all colors and the spot diagrams for all colors superimpose, some embodiments operate to un-distort the image projected on the retina by applying an electronic correction on the display side to produce a more rectangular virtual image on the retina.

In general, the distortion remaining is not due to the waveguide, which is responsible for little to no distortion. Most of the distortion is due to the prism. In some embodiments, this distortion can be electronically corrected since the prism is used in refraction, and refraction is much less dispersive than diffraction.

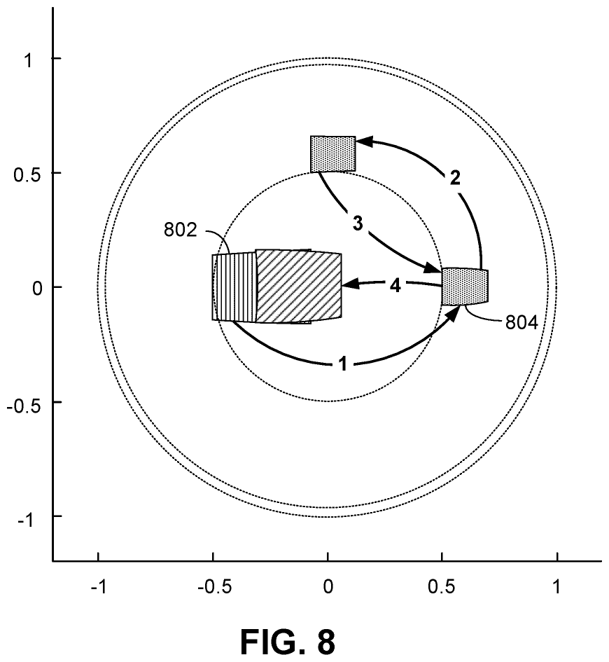

FIG. 8 is a circulation diagram illustrating the operation of a display in some embodiments. The range of kx-ky components of the input wave vectors before the prism are illustrated in the area 802. Once refracted by the prism and diffracted by the in-coupler (path 1), the resulting range of kx-ky components is shown at 804. The first EPE at 45° deviates the wave vectors to the vertical ky direction (path 2). The second EPE at 45 degrees, reflects them back (path 3) and the out-coupler gets the wave vectors back into air (path 4).

In the numerical example used here, due to the prism, the horizontal field of view after electronic corrections may be around 26.3° and the vertical field of view may be greater than 15°.

Example embodiments provide a system allowing the light engine to be oriented off axis and allow the glass plate of the waveguide to be non-perpendicular to the line of sight while providing an output image with little to no distortion. Some embodiments employ a prism in the imaging path of the light engine in order to compensate the waveguide. The waveguide, after the prism, will have substantially the same polar angles in and out.

Some embodiments employ a prism on top of the in-coupler which will deviate the light engine central axis in order to align with a desired central axis of out-coupler. Alternatively, other components may be used to deviate the light before it reaches the in-coupler. The prism functionality may in some embodiments be implemented as a holographic optical component (HOE) for instance.

In the operation of an example display, light from a pixel at position (x, y) in the image generator may pass through the prism and any other display optics, resulting in a beam with wavevector direction \hat{k}₀ that is in-coupled to the waveguide and subsequently out-coupled with wavevector direction \hat{k}₄ (which may be equal to \hat{k}₀, at least for components in the plane of the waveguide). The operation of the waveguide and associated optics may thus be described by a function F (x, y)=\hat{k}₄ that maps each pixel to an output wavevector direction. Conversely, for a desired wavevector direction \hat{k}₄, that function may be inverted, F⁻¹(\hat{k}₄)=(x, y), and the inverted function may be used to determine which pixels to illuminate to generate a beam with a desired output direction. Such a function may be used in processing an image to be displayed such that the resulting image does not exhibit the effects of distortion that might otherwise be introduced by the use of a prism. For example, a conventional prism-less display may generate an output beam with wavevector direction \hat{k}₄′ when a pixel at position (x′, y′) is illuminated. The operation of such a conventional display may be described by a function G (x′, y′)=. Combined with the above expression using F⁻¹, this gives

F⁻¹(G(x′,y′))=(x,y)

Using this or other techniques, an input image designed for a conventional prism-less display, with pixel values at positions (x′, y′), may be pre-processed to generate an input image for a display using a prism, with pixel values at positions (x, y).

In some embodiments, the pre-processing may also account for dispersive properties of the prism, which may result in red, green, and blue components being refracted to slightly different angles. For example, instead of using a single function F (x, y) to characterize the operation of the display, there may be three different functions F_{R} (x, y), F_{G} (x, y), and F_{R} (x, y), each one for a different color of the display. Such processing may also account for chromatic aberration effects that may be introduced by other optical components of the system.

Example embodiments allow for a waveguide display with waveguide glasses that are tilted to more naturally adapt to the human face. The light engine or other image generator may also be tilted outward to better accommodate the geometry of the glasses.

In some embodiments, the prism may be bonded to the waveguide. Such an arrangement may help protect the in-coupler grating (which may be a fragile surface relief grating) from abrasion. Different types of diffractive in-couplers gratings, such as holograms, may also benefit from such an arrangement

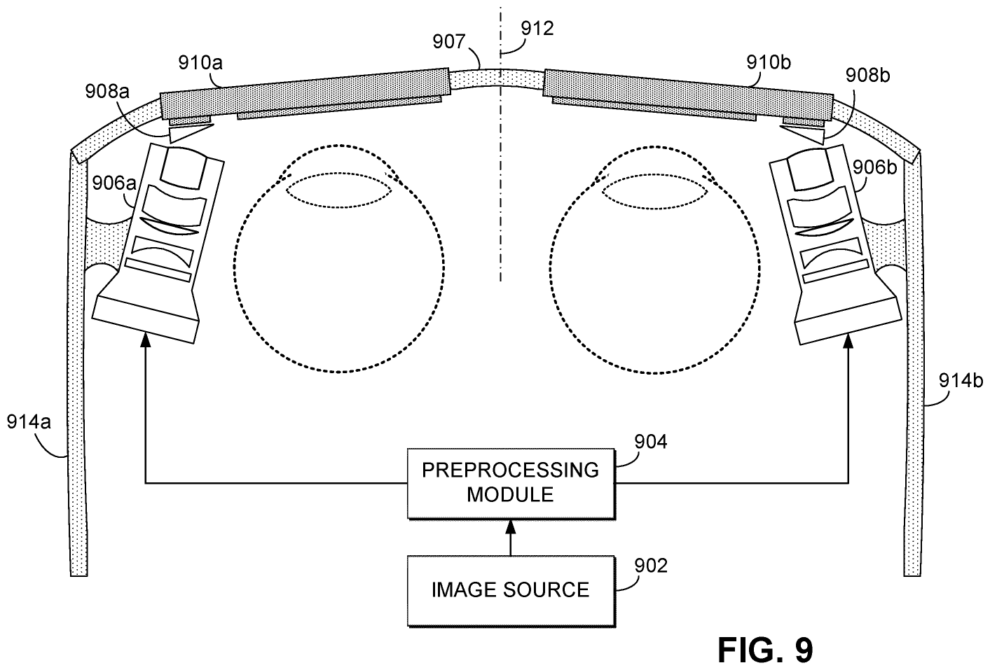

FIG. 9 is a schematic top view of a display apparatus with a glasses-style frame used in some embodiments. As illustrated in FIG. 9, an image (which may be one or more frames of a video) is provided by an image source 902, which may be, for example, a storage medium, a processor, a connection to a networked content source, or some combination of these. The image is provided to a preprocessing module 940 for processing to account for distortion and/or chromatic aberration introduced by the use of a prism in the display optics.

The preprocessing module may include hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. The preprocessing module may also include instructions executable for carrying out the one or more functions described as being carried out by the module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Image generators 906a, 906b generate light patterns corresponding to the input image or images. The light from the image generators is refracted by prisms 908a, 908b and coupled into the waveguides 910a, 910b for display.

The display apparatus of FIG. 9 may have a centerline 912 (which may be an axis of symmetry) parallel to a line of sight of the apparatus. In some embodiments, the waveguides are mounted in the frame such that a surface normal to each of the waveguides 910a, 910b is at an angle of around 5° with respect to the centerline (or line of sight). The waveguides may be joined by a bridge 907 or other frame component. An optical axis of each of the image generators 906a, 906b may be at an angle from the surface normal of the respective waveguide. For example, the image generators 906a, 906b may be at an angle of around 19.1° with respect to the surface normal (14.1° with respect to the centerline). The frame may include temple arms 914a, 914b, and the image generators 906a, 906b may be mounted inboard of the temple arms. In some embodiments, the image generators 906a, 906b may be mounted on and/or integrated with the temple arms.

In some embodiments, in addition to a lateral angle (in the plane of FIG. 19) with respect to the centerline, the image generators may be angled upward or downward, for example to provide a better fit with respect to the temples 914a, 914b and the volume expected to be occupied by a users head. The angles of the prisms 108a, 108b may be selected such that light emitted along the optical axis of the respective image generator is refracted to an angle that is ultimately out-coupled from the waveguide in a direction parallel to the centerline.

In some embodiments, as an alternative to, or in addition to, a prism such as prisms 602, 908a, 908b, one or more other light-deflecting optical elements may be employed. Such light-deflecting optical elements may be non-focusing light-deflecting optical elements. Such components or combinations thereof operate to deflect the image beam to hit the incoupler at an angle different from the angle resulting from the combination of the waveguide, temple and light engine tilt. However, light rays that are parallel when they enter a non-focusing optical element remain parallel after exiting the non-focusing optical element, so the use of a non-focusing optical element does not require redesigning an image generator or its associated optics for use in a particular frame. In example embodiments, each illuminated pixel of the image generator results in an output of a substantially collimated output beam made up of substantially parallel light rays, with different beam directions corresponding to different pixels. A non-focusing light-deflecting optical element, by preserving parallel rays, performs deflection of light from the image generator without introducing crosstalk between light from different pixels. To do this, the non-focusing light-deflecting optical element may be placed at a position in the optics of a display device where the light from each pixel has been collimated into a beam of substantially parallel rays. In example embodiments, distortion introduced by the non-focusing light-deflecting optical element can be compensated in software, e.g. with an image preprocessing module, whereas distortion introduced by an optical element that causes crosstalk between light from different pixels can be difficult or impossible to compensate in software.

In embodiments using a non-focusing light-deflecting optical element, the element may be positioned to deflect light after that.

In some such embodiments, a pair of mirrors is used as a light-deflecting optical element (e.g. as a non-focusing light-deflecting optical element). For example, in the illustration of FIG. 10, a pair of mirrors 1001, 1002 are provided along an optical path between a light engine or other image generator 1004 and an in-coupler 1006 of the waveguide 1008.

In this example, two mirrors are set in the illuminating light path. Their tilts are chosen to hit the incoupler under +5° and the combination of the two tilts deviate the image beam from −19.1° to +5°. The mirrors are configured with a size big enough to transmit the whole image. At the same time, the second mirror is spaced away from the first one so as not to shadow the image reflected by the second mirror.

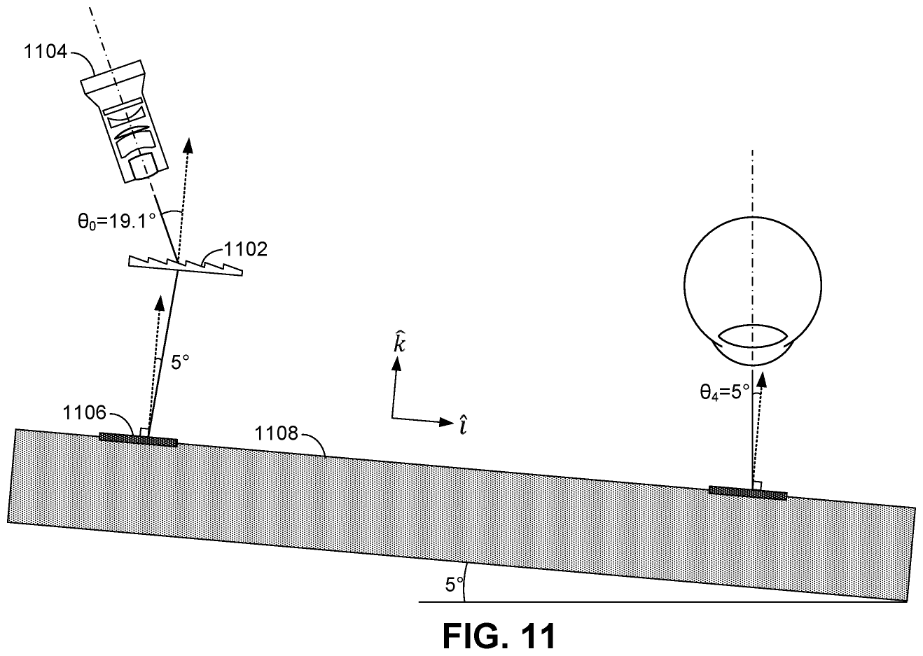

In some embodiments, a blazed prism is used as a light-deflecting optical element (e.g. as a non-focusing light-deflecting optical element). For example, in the illustration of FIG. 11, a blazed prism 1102 is provided along an optical path between a light engine or other image generator 1104 and an in-coupler 1106 of the waveguide 1208. Such an embodiment may be more lightweight than a conventional triangular prism.

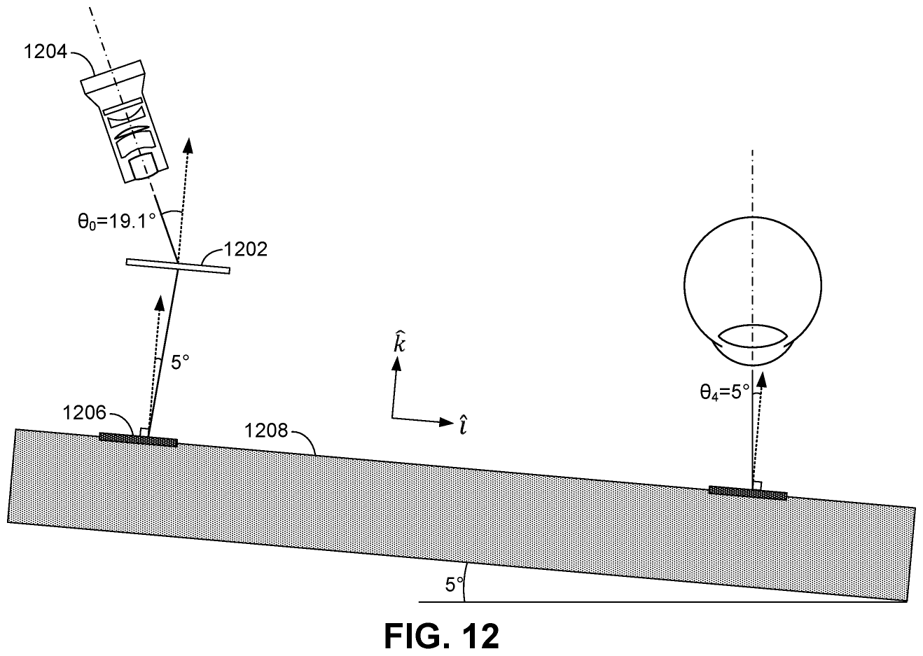

In some embodiments, a holographic optical element (HOE) is used as the light-deflecting optical element (e.g. as a non-focusing light-deflecting optical element). In the illustration of FIG. 12, a holographic optical element 1202 is provided along an optical path between a light engine or other image generator 1204 and an in-coupler 1206 of the waveguide 1208.

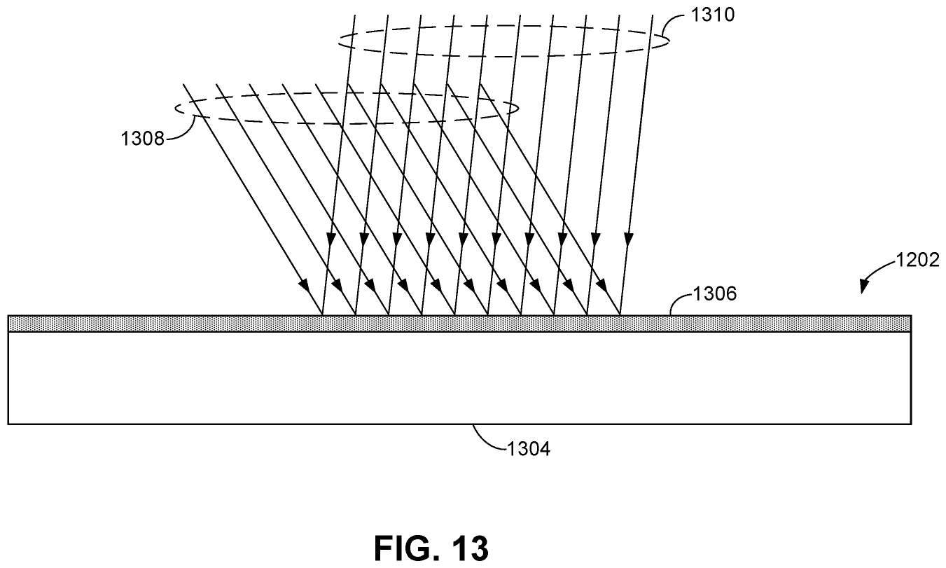

An example arrangement for recording a holographic element such as HOE 1202 is illustrated in FIG. 13. The holographic optical element 1202 may include a glass plate 1304 on which a layer 1306 of holographic recording material is provided. Two beams may be used for recording the holographic element. A first beam 1308 is directed onto the holographic recording material at a direction corresponding to the intended direction of the light-engine image, for example at an angle of −19.1°. A second beam 1310 is directed onto the holographic recording material from the direction of the intended transmission, for example an angle of +5°. After exposure of the holographic recording material to the interference pattern generated by the two beams and subsequent chemical processing, the final holographic optical element 1202 may be used in an embodiment such as that of FIG. 12. In some embodiments, to allow for the three wavelengths of an RGB image, a triple exposure of a panchromatic recording material can be made, each exposure with the corresponding wavelength.

In some embodiments, in order also to be able to deviate an image subtended by a solid angle and not only one sole direction, the recording is done with an image beam and a reference beam of the same subtended solid angle as the image one. Such a component has the advantage over the prism to suppress the chromatic dispersion.

As noted above, the arrangement of gratings shown in FIG. 4 has a generally S-shaped configuration. However, the principles described herein are not necessarily restricted to any particular arrangement of gratings.

An apparatus according to some embodiments includes an image generator, a waveguide having an in-coupler and an out-coupler, and a prism along an optical path between the image generator and the in-coupler.

In some embodiments, an optical axis of the image generator is mounted at an angle of at least 5° with respect to a normal to the waveguide.

In some embodiments, an optical axis of the image generator is mounted at an angle of at least 10° with respect to a normal to the waveguide.

In some embodiments, an optical axis of the image generator is mounted at an angle of about 19.1° with respect to a normal to the waveguide.

In some embodiments, the prism is configured to refract light emitted along the optical axis of the waveguide to a direction that is coupled out of the waveguide in a direction parallel to a line of sight.

In some embodiments, the prism is a triangular prism.

In some embodiments, the waveguide is a first waveguide in a binocular display having two waveguides. In some such embodiments, the binocular display has a centerline, and a normal to the first waveguide is oriented at an angle of at least 2° away from the centerline. In some such embodiments, the normal to the first waveguide is oriented at an angle of about 5° away from the centerline. In some embodiments, a normal to the second waveguide is oriented at an angle of at least 2° away from the centerline. In some embodiments, a normal to the second waveguide is oriented at an angle of about 5° away from the centerline.

Some embodiments further include a preprocessing module, where the preprocessing module is operative to preprocess a received image to account for distortion introduced by the prism.

An apparatus according to some embodiments includes an image generator having an optical axis; a waveguide having an in-coupler and an out-coupler, wherein the waveguide is not normal to the optical axis of the image generator; and a light-deflecting component along an optical path between the image generator and the in-coupler; where the light-deflecting component is operative to deflect light emitted along the optical axis of the image generator to a direction such that the light is out-coupled at a direction substantially parallel to a line of sight.

In some embodiments, the light-deflecting component is a prism.

In some embodiments, the light-deflecting component is a holographic optical component.

A method according to some embodiments includes emitting light representing an image from an image generator along an optical path toward an in-coupler of a waveguide, wherein the waveguide is not normal to an optical axis of the image generator, and deflecting the emitted light using a light-deflecting component such that light emitted along the optical axis is deflected to a direction such that the light is out-coupled at a direction substantially parallel to a line of sight.

In some embodiments, the method further includes receiving image information; and preprocessing the received image information to account for distortion introduced by the light-deflecting component to generate a processed image, wherein the light emitted from the image generator is based on the preprocessed image.

In the present disclosure, modifiers such as “first,” “second,” “third,” and the like are sometimes used to distinguish different features. These modifiers are not meant to imply any particular order of operation or arrangement of components. Moreover, the terms “first,” “second,” “third,” and the like may have different meanings in different embodiments. For example, a component that is the “first” component in one embodiment may be the “second” component in a different embodiment.

Although features and elements are described above in particular combinations, one of ordinary skill in the art will appreciate that each feature or element can be used alone or in any combination with the other features and elements.

1. An apparatus comprising:
an image generator;
a waveguide having an in-coupler and an out-coupler; and
a light-deflecting optical element along an optical path between the image generator and the in-coupler, the light-deflecting optical element comprising at least one of a single prism, a blazed prism, two mirrors, or a holographic optical element; and
a preprocessing module, the preprocessing module being operative to preprocess a received image to account for chromatic aberration introduced by the light-deflecting optical element.

2. The apparatus of claim 1, wherein the apparatus comprises a frame having a temple arm, and the image generator is mounted inboard of the temple arm.

3. The apparatus of claim 1, wherein the light-deflecting optical element is a non-focusing optical element.

4. The apparatus of claim 1, wherein an optical axis of the image generator is mounted at an angle of at least 5° with respect to a normal to the waveguide.

5. The apparatus of claim 1, wherein an optical axis of the image generator is mounted at an angle of at least 10° with respect to a normal to the waveguide.

6. The apparatus of claim 1, wherein an optical axis of the image generator is mounted at an angle of about 19.1° with respect to a normal to the waveguide.

7. The apparatus of claim 1, wherein the prism is configured to refract light emitted along the optical axis of the waveguide to a direction that is coupled out of the waveguide in a direction parallel to a line of sight.

8. The apparatus of claim 1, wherein the optical element comprises a single prism.

9. The apparatus of claim 1, wherein the optical element comprises a blazed prism.

10. The apparatus of claim 1, wherein the optical element comprises two mirrors.

11. The apparatus of claim 1, wherein optical element is a holographic optical element.

12. The apparatus of claim 1, wherein the waveguide is a first waveguide in a binocular display having two waveguides.

13. The apparatus of claim 12, wherein the binocular display has a centerline, and wherein each of the waveguides has a normal that is oriented at an angle of at least 2° away from the centerline.

14. The apparatus of claim 12, wherein the binocular display has a centerline, and wherein each of the waveguides has a normal that is oriented at an angle of about 5° away from the centerline.

15. (canceled)

16. A method comprising:
emitting light representing an image from an image generator along an optical path toward an in-coupler of a waveguide, wherein the waveguide is not normal to an optical axis of the image generator; and
deflecting the emitted light using a light-deflecting optical element such that light emitted along the optical axis is deflected to a direction such that the light is out-coupled at a direction substantially parallel to a line of sight, the light-deflecting optical element comprising at least one of a single prism, a blazed prism, two mirrors, or a holographic optical element;
further comprising preprocessing the image to account for chromatic aberration introduced by the light-deflecting optical element, wherein the light emitted from the image generator is based on the preprocessed image.

17. The method of claim 16, wherein the method is performed on a binocular display, and the line of sight is parallel to a centerline of the binocular display.

18. The method of claim 16, wherein the light-deflecting optical element is a non-focusing optical element.

19. (canceled)

20. The method of claim 16, wherein the optical element comprises a single prism.
